(19) United States
(12) Patent Application Publication
(10) Pub. No.: US 2016/0246763 A1
(43) Pub. Date: Aug. 25, 2016

(54) CHARACTER STRING DISPLAY DEVICE

(71) Applicant: MITSUBISHI ELECTRIC CORPORATION, Tokyo (JP)

(72) Inventors: Hirohiko HIGUCHI, Tokyo (JP); Hirofumi FUKAGAWA, Tokyo (JP)

(73) Assignee: MITSUBISHI ELECTRIC CORPORATION, Tokyo (JP)

(21) Appl. No.: 15/027,671

(22) PCT Filed: Aug. 20, 2014
(86) PCT No.: PCT/JP2014/004248

§ 371 Date: Apr. 6, 2016

(30) Foreign Application Priority Data
Oct. 18, 2013 (JP) 2013-216962

(51) Int. Cl. G06F 17/21; G06F 3/0484; G06T 11/00; G09G 5/26; G09G 5/30

(52) U.S. Cl. CPC G06F 17/214; G09G 5/26; G09G 5/30; G06T 11/001; G06F 17/212; G06F 3/04845; G06F 3/04847

(57) ABSTRACT

There is provided a display device that displays both of main and sub texts (Japanese and English, title and auxiliary explanation, or the like) corresponding to each other on a screen. Even when display priorities (such as character sizes) in the main and sub texts are varied, the display device does not produce unnecessary blank spaces and does not disarrange the screen layout, to display strings in good visibility. For a screen having plural composite display areas each of which includes a main text and a sub text, the display device includes a main text character size control unit to calculate a common character size at which the main text strings are fitted into respective main text display areas, and a sub text character size control unit to calculate a common character size at which the sub text strings are fitted into respective sub text display areas, wherein the display device arranges the plural main and sub texts in respective display areas, using character sizes calculated by the main and sub text character size control units.

### TECHNICAL FIELD

The present invention relates to a character string display device that displays, on a same screen, plural string pairs of main and sub texts corresponding to each other.

### BACKGROUND ART

In Patent Document 1, a measuring device for displaying plural languages together on a same screen is configured so as to have plural fixed string display areas on the screen for displaying in a first language and a second language, and so as to display strings in arbitrarily selected languages in the respective display areas.

In Patent Document 2, a bilingual-edition translator display device is configured so as to change, in a case where an original text and a text translated therefrom differ in length on the display screen, respective display area sizes to display the original and translated texts with their text end positions aligned.

### PRIOR ART DOCUMENT

### Patent Document

Patent Document 1: Japanese Patent No. 5070122

Patent Document 2: Japanese Patent Laid-Open Publication No. S63-226768

### SUMMARY OF THE INVENTION

### Problems to be Solved by the Invention

In a conventional technique, when main and sub texts corresponding to each other (such as a Japanese text and English one, or a title and auxiliary explanation) are displayed together and display priority degrees (such as respective display area sizes, or character sizes) of the main/sub texts are changed, unnecessary blank spaces are sometimes produced. An effort to fill the blank spaces has sometimes caused disarrangement of screen layout, or lack of uniformity in character sizes in items listed in parallel.

For example, in Patent Document 1, in order to raise a display priority degree of the first language (main text) and lower that of the second language (sub text), it is possible not to choose displaying of the second language, to disable displaying thereof; however, this causes an area for displaying the second language to become a blank. Furthermore, there has been a problem that although the area to display the second language is blank with only the first language being displayed, it is impossible to utilize such blank second area for enlarging the display area size of the first language and the character size thereof, because the respective display areas for the first and second languages are fixed.

Furthermore, Patent Document 2 discloses a technique in which in order to align the text ends of an original text (main text) and a translated text (sub text) whose string lengths are different, respective display area sizes are changed. However, such a technique naturally determines an optimum ratio according to the ratio between the lengths of the original text and translated text, having caused a problem that it is impossible to display at an arbitrary display ratio. Furthermore, even though an arbitrary display ratio can be specified, a blank is produced in the display area, or a string exceeds the display area, which causes a problem that the screen layout is disarranged.

The present invention is made to solve the above-mentioned problems and to obtain a character string display device that can display in parallel, on a screen, strings of a main text and a sub text corresponding to each other without disarranging the screen layout, even when the display area size ratio or the character size ratio between the strings of the main text or sub text is changed.

### Means for Solving Problem

A string display device according to the present invention includes: a display unit on which plural composite display areas are arranged each of which has a fixed area size and includes a main text display area and a sub text display area whose display area sizes are mutually variable; a display-content recording unit to record display data including the main and sub text display areas to be displayed in the composite display areas and main and sub text strings formatted to be displayed in the main and sub text display areas, respectively; a display-area-size-ratio input unit with which a display area size ratio between the main and sub text display areas is inputted; and a character size control unit to calculate area sizes of the main and sub text display areas in accordance with the display area size ratio, calculate, using string lengths of main texts and string lengths of sub texts, a common character size for the strings of main texts recorded in the display-content recording unit and a common character size for the strings of sub texts recorded therein so that the strings of the main and sub texts can be arranged in the calculated main and sub text display areas, respectively, and change the display data including the main and sub text display areas recorded in the display-content recording unit and the main and sub text strings recorded therein, into display data including the calculated main and sub text display areas and the main and sub text strings with their character sizes set at the respective common character sizes.

Furthermore, a string display device according to the present invention includes: a display unit on which plural composite display areas are arranged each of which has a fixed area size and includes a main text display area and a sub text display area whose display area sizes are mutually variable; a display-content recording unit to record display data including the main and sub text display areas to be displayed in the composite display areas and main and sub text strings formatted to be displayed in the main and sub text display areas, respectively; a display-character-size-ratio input unit including an input value convert unit to convert, on the basis of each of area size ratios between main text strings and sub text strings when displayed at a common character size, a display character size ratio between strings of a main text and a sub text to a display area size ratio between display areas for the main text and the sub text; and a character size control unit to calculate area sizes of the main and sub text display areas in accordance with the display area size ratio, calculate, using string lengths of main texts and string lengths of sub texts, a common character size for the strings of main texts recorded in the display-content recording unit and a common character size for the strings of sub texts recorded therein so that the strings of the main and sub texts can be arranged in the calculated main and sub text display areas, respectively, and change the display data including the main and sub text display areas recorded in the display-content recording unit and the main and sub text strings recorded therein, into display data including the calculated main and sub text display areas and the main and sub text strings with their character sizes set at the respective common character sizes.

### Effect of the Invention

In the present invention, common character sizes for the strings of main texts and second texts are set so that the main texts and second texts can be arranged within display areas for the main texts and sub texts, whose area sizes have been changed according to an area size ratio arbitrarily set between the main and sub text display areas or according to a character size ratio arbitrarily set between strings of the main and sub texts; therefore, even in a case where the display area size ratio or the character size ratio is arbitrarily changed, the strings of the main text and the sub text can be displayed on a screen without disarranging screen layout.

### BRIEF DESCRIPTION OF THE DRAWINGS

FIG. 1 is a configuration diagram of a character string display device according to Embodiment 1 of the present invention;

FIG. 2 is a schematic image of a screen according to Embodiment 1 of the present invention;

FIG. 3 is a flow chart for explaining operations of the present invention;

FIG. 4 are schematic diagrams showing the states of display areas of main texts and sub texts that change according to input operations;

FIG. 5 is a flow chart of a process to uniformalize character sizes of the main texts and sub texts;

FIG. 6 is a list of ratios between main text (first language) display areas and main text strings;

FIG. 7 is a list of the average and the standard deviation of ratios between the main text (first language) display areas and the main text strings;

FIG. 8 is a schematic graph of a normal distribution for explaining a concept of an upper limit value under an assumption that ratios of the main and sub text strings are normally distributed;

FIG. 9 is a list of ratios between sub text (second language) display areas and sub text strings;

FIG. 10 is a list of the average and the standard deviation of ratios between the sub text (second language) display areas and the sub text strings;

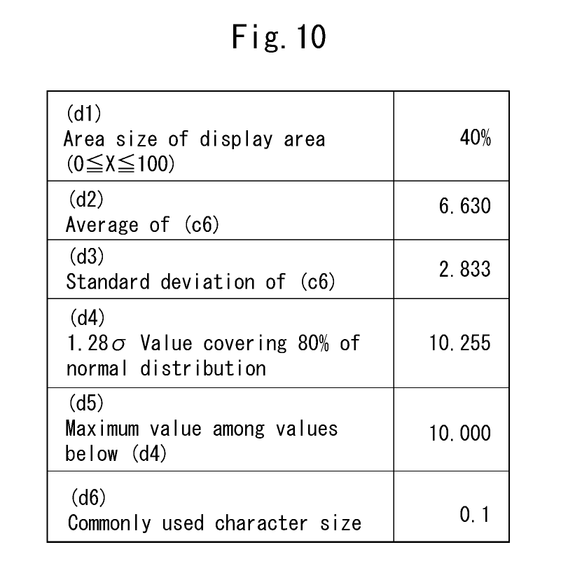

FIG. 11 are schematic diagrams illustrating a process until completing uniformalization of character sizes of main texts;

FIG. 12 are schematic diagrams illustrating a process until completing uniformalizing respective character sizes of the main texts and sub texts;

FIG. 13 is a schematic diagram showing a state in which display area sizes of the main text and the sub text are made equal;

FIG. 14 is a schematic diagram showing a state in which display character sizes of the main text and the sub text are made equal;

FIG. 15 are graphs showing relations of display area size ratios of the main text and the sub text in a case where there is a string length difference therebetween and a case where there is not;

FIG. 16 is a flow chart of a character size uniformalization process in which a character size ratio is given as an input value;

FIG. 17 are schematic images showing states in which character colors are changed according to changes in character sizes;

FIG. 18 is a graph showing relations between the text display ratios of the main text and the sub text, and the character contrasts; and

FIG. 19 are examples of plural languages displays and other displays.

### MODES FOR CARRYING OUT THE INVENTION

### Embodiment 1

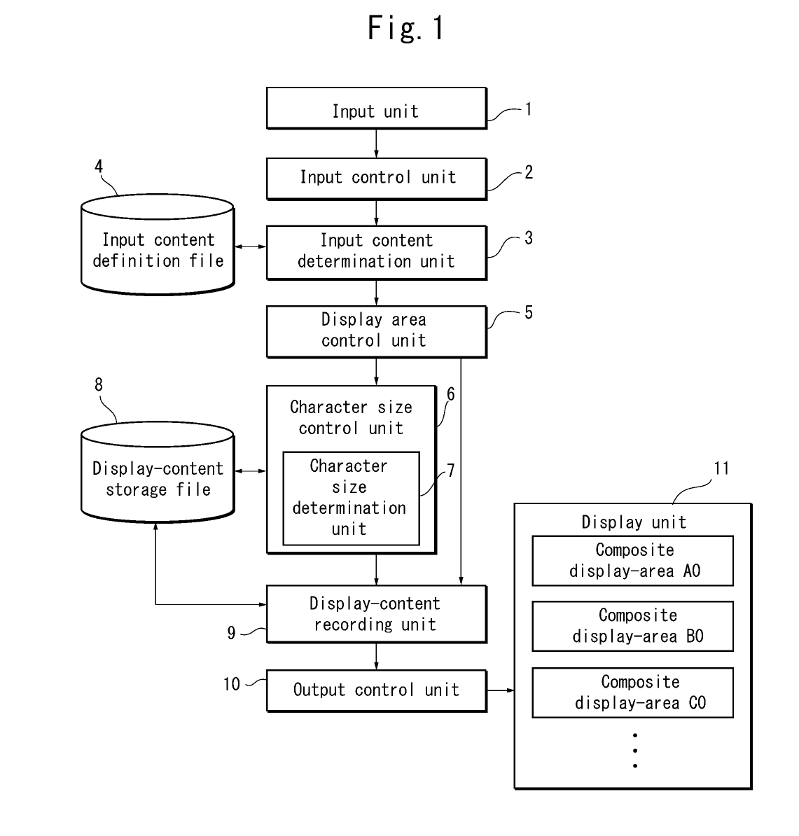

FIG. 1 is a configuration diagram of a character string display device according to Embodiment 1 of the present invention. The character string display device is configured with an input unit 1, an input control unit 2, an input content determination unit 3, an input content definition file 4, a display area control unit 5, a character size control unit 6 including a character size determination unit 7, a display-content storage file 8, a display-content recording unit 9, an output control unit 10, and a display unit 11. The input unit 1 is an input device such as a mouse, a touch panel, a cursor key, or a mechanical operation switch. The input control unit 2 determines whether or not there is an input from the input unit 1. In a case where there is an input, the input content is outputted to the subsequent input content determination unit 3. The input content determination unit 3 refers to the input content definition file 4 storing process contents each corresponding to individual input contents, to determine a process corresponding to the content of the input. The input content definition file 4 stores not only a display area size ratio set for main and sub texts relating to the present invention, but also different kinds of input contents such as backward and forward page-turn operations, and image expansion and reduction operations. For example, in a case of inputting through a mouse or a touch panel, coordinates of cursor positions or touched positions are stored. When determining that the input content is to change the display area size ratio between main and sub texts, the input content determination unit 3 outputs the inputted display area size ratio between main and sub texts to the display area control unit 5. The display area control unit 5 outputs the main-sub text display area size ratio specified by a user with the input unit 1, to the character size control unit 6 and the display-content recording unit 9. The character size control unit 6 refers, from text data, display typefaces, formats, display colors, or the like of the main and sub text strings stored in the display-content storage file 8, and from the area size, the shape, display-position coordinate data, and the like of the composite display area stored therein, to the character numbers or the string lengths of the main and sub text display strings and a composite display area size combined for the main text and the sub text. The character size determination unit 7 calculates, according to the main-sub text display area size ratio, display area sizes for the main text and the sub text that are recorded in the display-content recording unit 9 and being displayed on the display unit 11, and then calculates character sizes allowing the texts to fit in the changed display areas. The calculated character sizes are outputted to the display-content recording unit 9. On the basis of the display area size ratio outputted from the display area control unit 5, the display-content recording unit 9 determines a main text display area and a sub text display area; on the basis of information from the character size control unit 6 and the display-content storage file 8, the display-content recording unit re-stores a main text display area within each composite display area and a sub text display area therewithin and re-stores a main text string and a sub text string arranged in the main text display area and the sub text display area. The output control unit 10 outputs output-information produced by the display-content recording unit 9 to the display unit 11 to change contents to be displayed in a composite display area A0, a composite display area B0, a composite display area C0 . . . . The display unit 11 is a display device such as a display to display a specified content. In addition, the input control unit 2, the input content determination unit 3, the display area control unit 5, the character size control unit 6, and the output control unit 10 are control members for controlling the display-content recording unit 9 and the display unit 11 to update screen data.

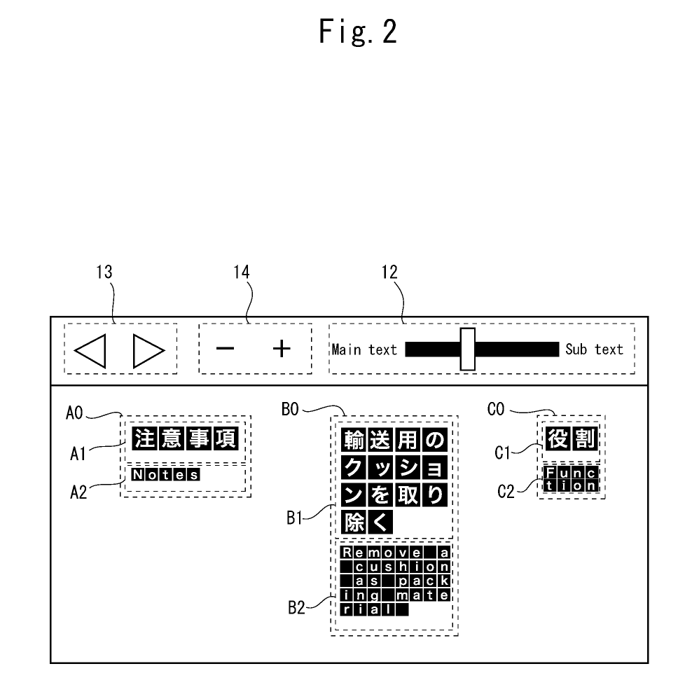

FIG. 2 is a screen display example according to Embodiment 1 of the present invention. On the screen of the display unit 11, there are provided a display-area-size-ratio input unit 12 for the user to specify a display area size ratio between the main text display area and sub text display area, a back-and-forth-page-turning input unit 13 to turn pages back and forth, and an image expansion-and-reduction input unit 14. These units designated by 12, 13, and 14 correspond to the input unit 1 in FIG. 1. On the screen, the plural composite display areas A0, B0, and C0 to display main texts and sub texts together are formed. Furthermore, main text display areas A1, B1, and C1 to display the main texts and sub text display areas A2, B2, and C2 to display the sub texts are formed in the composite display areas A0, B0, and C0. In addition, the main text and the sub text in each display area have such a relation that the texts express an equivalent meaning in plural languages. The display-area-size-ratio input unit 12 may be provided with a special-purpose input interface as shown in the screen display example, or may be an interface in which the boundary line between the main text and the sub text is directly moved by touch inputs or moving a cursor with a mouse. All display ratios between the main texts and the sub texts are simultaneously controlled by the display-area-size-ratio input unit 12. In a case where the display-area-size-ratio input unit 12 is the interface in which the boundary line between the main text and the sub text is directly moved, boundary lines in composite display areas other than the composite display area being directly operated are simultaneously changed together to the same ratio. In addition, FIG. 2 shows a display example in which the user operates the display-area-size-ratio input unit 12 to change display area size ratios between the main sub text display areas, from 50:50 to 60:40.

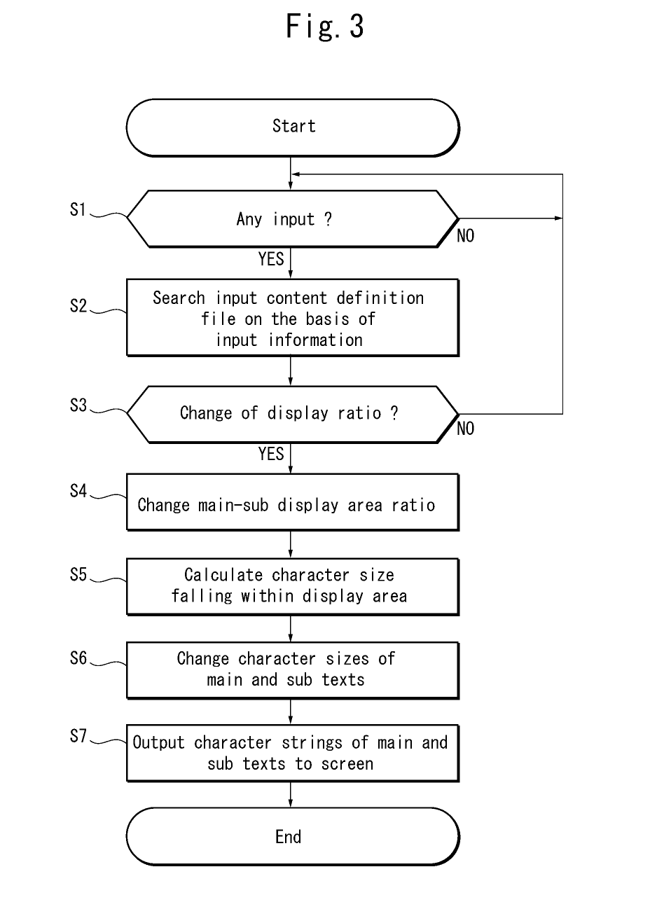

FIG. 3 is a flow chart for explaining operations of Embodiment 1 of the present invention. In addition, using FIG. 1 to FIG. 3, explanation will be made about, for convenience of explanation, an example case where “main text display area:sub text display area” that the display-content recording unit 9 stores as screen data currently being displayed on the display unit 11 is changed from a state of 50:50 to a state of 60:40. Firstly, when the user operates the display-area-size-ratio input unit 12 to change the display area size ratio between the main sub text display areas, from 50:50 to 60:40, the input control unit 2 checks whether or not the user performs an input operation (the mouse, the touch panel, or the like) (S1). When it is determined that an input operation has been made, the input content determination unit 3 searches the input content definition file 4 to extract a process corresponding to an inputted content (S2). In this case, the input content determination unit 3 determines that the inputted content is a modification in the display area size ratio between display areas of the main text and the sub text, to output the inputted modification content to the display area control unit 5 (S3). In accordance with the modification content, the display area control unit 5 modifies area size ratios between the main and sub texts in the plural composite display areas to be modified, from 50:50 to 60:40 (S4). The character size control unit 6 calculates a maximum character size commonly used for the main text strings and a maximum character size commonly used for the sub text strings so that at the maximum character sizes, the whole strings are fitted, without overflowing, into respective display areas changed by the character size determination unit 7 (S5). Then, the display-content recording unit 9 is controlled so that individual character sizes of plural main text strings and sub text strings stored in the display-content recording unit 9 are changed to the calculated maximum character size (S6). The display-content recording unit 9 receives data of the character size calculated by the character size control unit 6 and the display area size ratio changed by the display area control unit 5 to modify to the received data, the previously stored data of main and sub text display areas and the character sizes of the main and sub text strings corresponding to the main and sub text display areas, and then re-store the screen data. The output control unit 9 outputs the screen data re-stored by the display-content recording unit 9 to the display unit 11 to change a screen display state into that of 60:40 (S7). In addition, in a case where the user wants to display, instead of text data being displayed on the display unit 11, text data on the previous or the next page, the user operates the back-and-forth-page-turning buttons 13 to specify desired text data. In this case, the control unit searches the display content storage file 8 for the specified text data and makes the display-content recording unit 9 store the specified text data, data such as the composite display area, the main and sub text display areas changed in accordance with the display area size ratio between the main text display area size and the sub text display area size, and the common character size data. By these operations, the stored data is displayed to the display unit 11 through the output control unit 10.

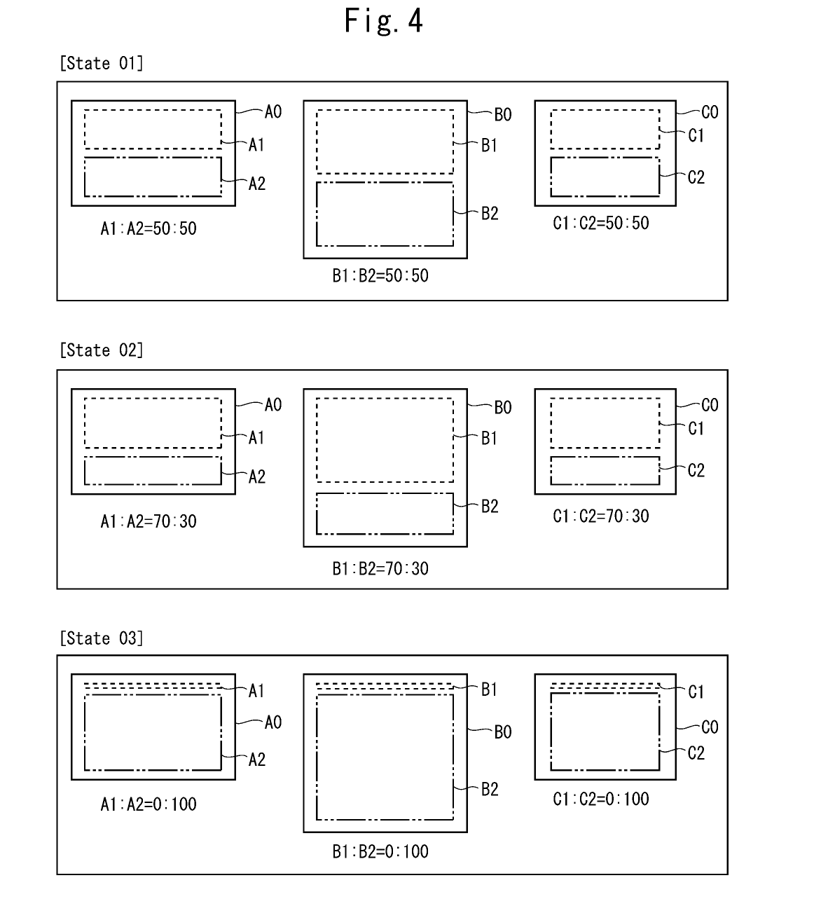

FIG. 4 are illustrations of states of plural string display areas changed according to input operations. A0 is a composite display area; A1, a main text display area; A2, a sub text display area. Each area size of the composite display areas A0, B0, and C0 is arbitrarily fixed as a component constituting a screen design. An area size of the main text display area A1 combined with the sub text display area A2 is equal to that of the composite display area A0. The same goes for B0 and C0. Furthermore, every composite display area has a same area size ratio between its main and sub text display area sizes (A1:A2=B1:B2=C1:C2). In a state 01, the display area size ratio between the main and sub text display areas is 50:50. Although the area sizes of the areas A0, B0, and C0 are different, the character sizes of the main texts are common among individual areas, or are made as close as possible; and the character sizes of the sub texts are also common among individual areas, or are made as close as possible (in character size, A1=B1=C1 and A2=B2=C2). In a state 02, an input operation has been made through the display-area-size-ratio input unit 12 so that the display area size ratio between the main and sub text display areas is set to 60:40; and in a state 03, the display area size ratio has been set to 0:100. In the state 03 of FIG. 4, areas A1, B1, and C1 are expediently expressed as long and narrow rectangles, but they actually have no area sizes.

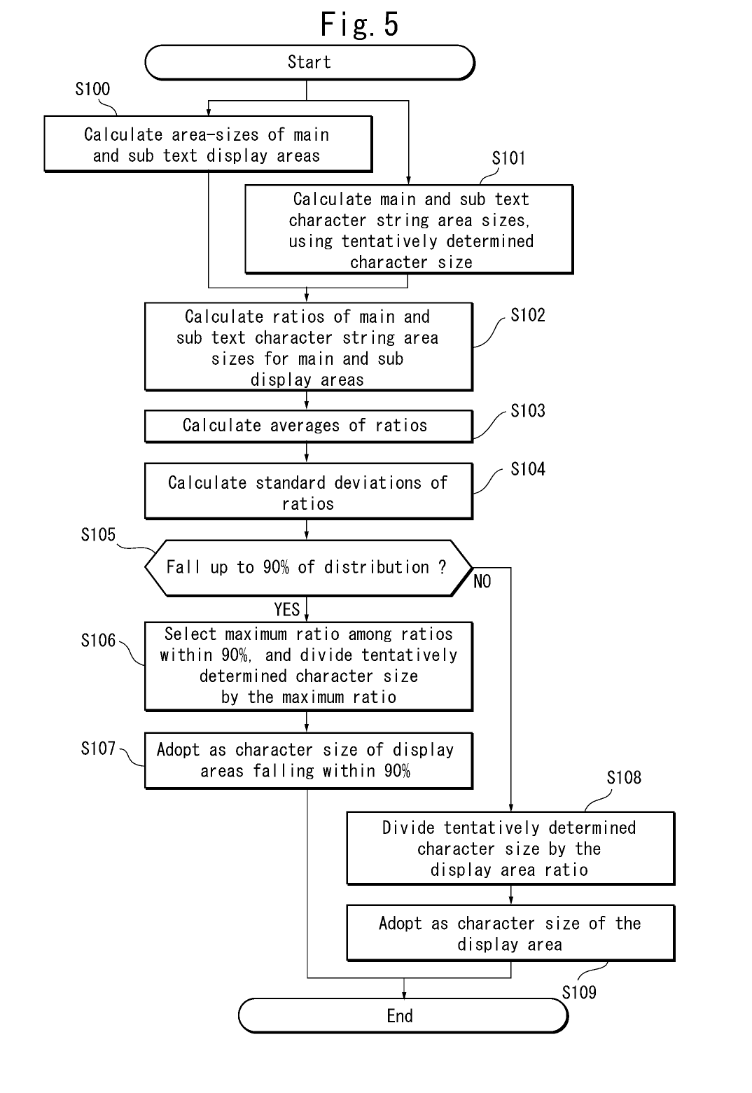

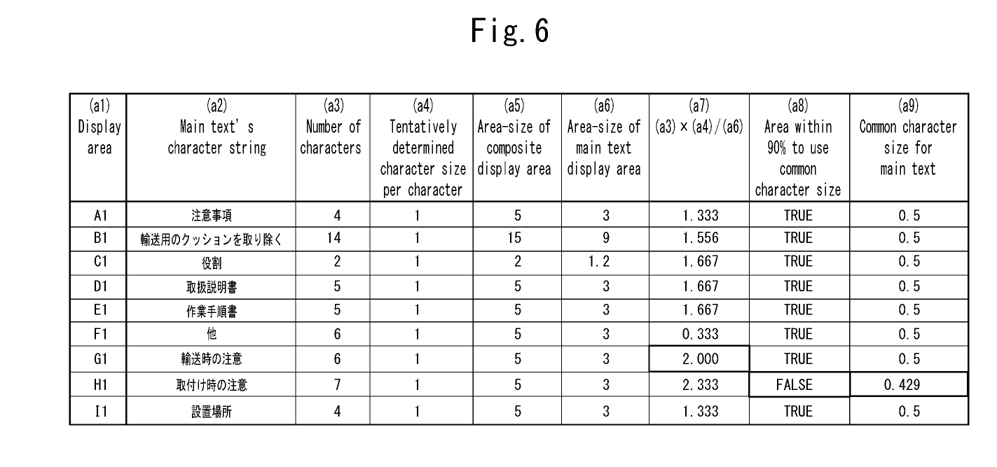

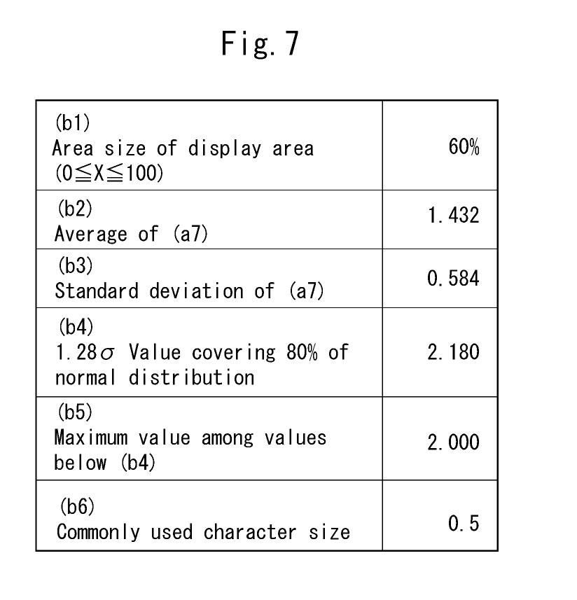

FIG. 5 is a flow chart showing a process to calculate a common character size in Embodiment 1 of the present invention, and explaining about a process (S5) of the character size control unit 6 in FIG. 1. Here, explanation will be made about an example in which the character size of the main texts is calculated in a case where the main texts are in the first language and the sub texts are in the second language, and the display area size ratios between the main and sub texts are changed to 60:40. In addition, uniformalization of character sizes in 90% of all main texts shall fulfill a requirement that “in individual main text display areas, the character sizes are as close as possible”. The display screen is assumed, as shown in FIG. 2, to have a configuration in which the individual composite display areas' positions and area sizes are fixed; in each composite display area, a main and sub text display areas are arranged upward and downward, respectively; and the position of the boundary line is varied upward and downward. Prior given information in the character size control unit 6 (FIG. 1) is strings (FIG. 6, a2) of the main texts (first language), the area sizes (FIG. 6, a5) of the composite display areas, and main texts' area size ratios (FIG. 7, b1).

Firstly, the character size determination unit 7 of the character size control unit 6 multiplies composite display area sizes (a5) indicated in FIG. 6 by a main text area size ratio of 60% (b1) indicated in FIG. 7, thereby obtaining the area sizes (a6) of main text display areas A1 to I1 (S100). Furthermore, the character size control unit calculates (S101) the number of characters (FIG. 6, a3) included in each of main text strings (a2) corresponding to respective main text display areas A1 to I1. For each of the main text display areas A1 to I1, the character size control unit uses the calculation result and calculates (S102) a main text string display area size (a3×a4) and the ratio (a7) thereof to the main text display area size (a6) under assumption that the character size of a single character is one. Using the same procedure, the character size control unit calculates ratios in respective main text display areas A1 to I1.

Next, the character size control unit calculates main text string display area sizes and the ratios (a7) thereof to main text display area sizes (a6) under assumption that the character size of a single character is one. Among these ratios, the character size control unit selects a maximum value, and divides the prior assumed character size of one by the maximum value to determine that the division result is a common display character size for all main text display areas. In the example of FIG. 6, the display character size of H1 is approximately 0.429 to be determined as the common character size.

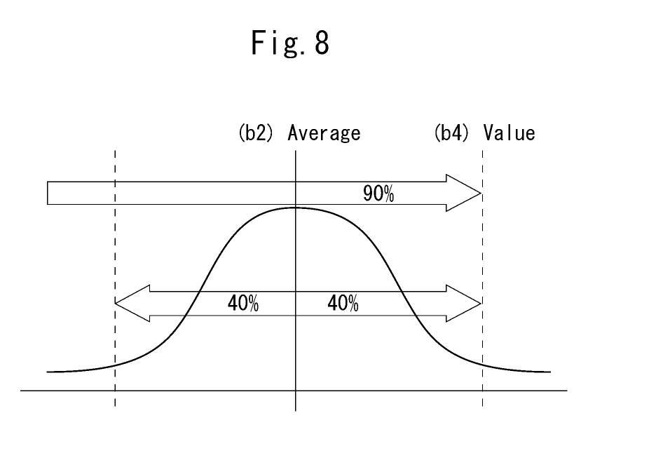

Furthermore, the average (b2) of ratios (a7) of the display areas A1 to I1 is calculated (S103), and then the standard deviation of the ratios (a7) of the display areas A1 to I1 may be calculated (S104). In order to uniformalize character sizes in 90% of the plural main text display areas, under an assumption that respective ratios of the areas A1 to I1 follow a normal distribution, an upper limit value that covers 90% of the normal distribution, that is approximately 1.28σ, will be obtained (FIG. 8). In this example, the ratio corresponding to the 90% upper limit value is approximately 2.18. This means that 90% of the ratios (a7) previously calculated for the main texts in the areas A1 to I1 will be within approximately 2.18 (b4).

In S105, each of the previously calculated ratios (FIG. 6, a7) is evaluated to be larger than approximately 2.18 or to be smaller. A maximum value is selected among ratios (a7) smaller than approximately 2.18; the character area size of one which is previously assumed for a single character is divided by the maximum value of 2.000, then it is determined that the division value is a common character size for display areas whose ratios (a7) are smaller than approximately 2.18 (S106, S107). Furthermore, for the display area having (a7) of approximately 2.333 larger than approximately 2.18, the character area size of one which is previously assumed for a single character is divided by approximately 2.333, so that it is determined that the result value is its display character size (S108, S109).

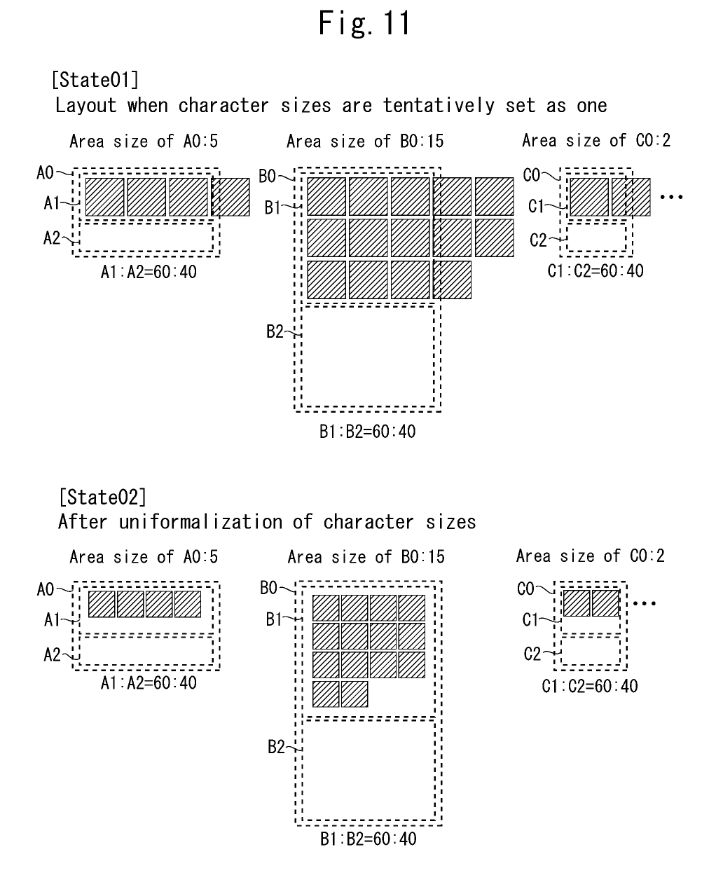

By the above procedure, the character size of H1 including lot of characters in comparison to its main text display area size becomes approximately 0.429; however, other character sizes can be uniformalized to 0.5. In this example, by uniformalizing character sizes in 90% of the display areas, the requirement that “the character sizes of respective areas are as close as possible” is satisfied; however, if it is regarded that the requirement is satisfied, any other ratio (80%, 85%, 95%, and the like) may be used for uniformalization. FIG. 11 show text display areas' states varying according to these character size uniformalization processes. A state 01 shows a state before application, and a state 02 shows a state thereafter. Furthermore, when the above-described ratio is 100%, it is equivalent to selecting a maximum value among the ratios (a7) between the main text string display area sizes and the main text display area sizes (a6) under assumption that the character size of a single character is one.

The above procedure is a character size uniformalization procedure for the main texts; a character size uniformalization procedure for the sub texts is a similar one. In cases of sub texts, prior given information for sub texts is strings of the sub texts (second language), the area sizes of the composite display areas, and display area size ratios between the main texts and the sub texts.

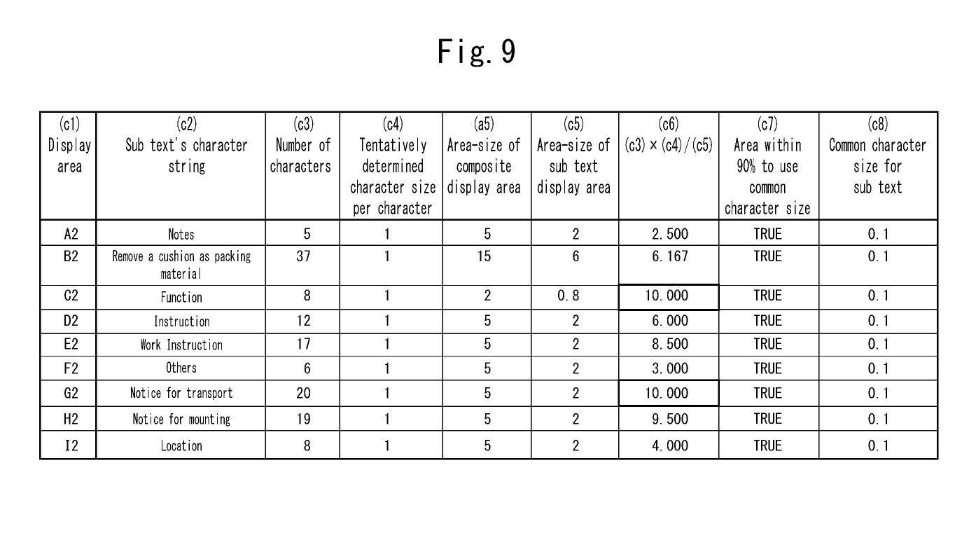

Firstly, the character size determination unit multiplies composite display area sizes (a5) indicated in FIG. 9 by a sub text area size ratio (d1), thereby obtaining sub text display area sizes A2 to I2 (S100). Furthermore, the character size control unit calculates (S101) the number of characters (FIG. 9, c3) included in each of sub text strings (c2) corresponding to respective sub text display areas A2 to I2. For each of the sub text display areas A2 to I2, the character size control unit uses the calculation results and calculates (S102) a sub text string display area size (c3×c4) and the ratio (c6) thereof to the sub text display area size (c5) under assumption that the character area size of a single character is one. Using the same procedure, the character size control unit calculates ratios in respective sub text display areas A2 to I2.

Next, the average (d2) of the ratios (c6) of the display areas A2 to I2 is calculated (S103), and then the standard deviation of the ratios (c6) of the display areas A2 to I2 is calculated (S104). In order to uniformalize character sizes in 90% of the text display areas, under an assumption that respective ratios of the areas A2 to I2 follow a normal distribution, an upper limit value that covers 90% of the normal distribution, that is approximately 1.28σ, will be obtained (FIG. 8). In this example, the ratio corresponding to the 90% upper limit value is approximately 10.255. For all sub texts, the previously calculated ratios (a7) stay within approximately 10.255 (c7).

A maximum value is selected among ratios (a7) smaller than approximately 10.255; the tentative character area size of one, which is previously assumed for a single character, is divided by the maximum value of 10.255, then it is determined that the division value is a common character size for display areas whose ratios (a7) are smaller than approximately 10.255 (S106, S107). In this case, the maximum value is 10.000, thus the common character size for all sub texts is determined as 0.1.

In the above explanation, the tentative area size for a single character has been determined as one; however, it has also been assumed that typeface having a same width are used. In a case where a proportional (variable width) typeface, in which each character has a different character width, is used, a tentative string area size may be calculated by tentatively determining a character height, calculating the length of a string when arranged using the height, and multiplying the height by the length.

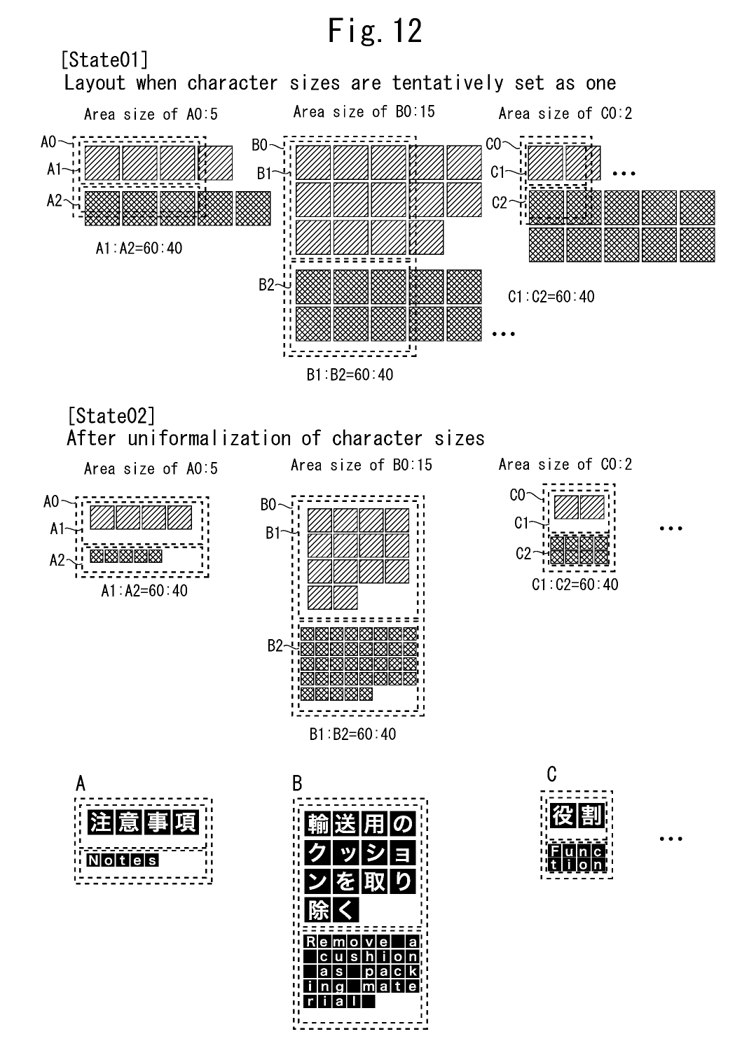

FIG. 12 show states of the main and sub display areas when respective main and sub texts are varied by the character size uniformalization process. Here, description has been made about combinations of two texts of main texts and sub texts; however, it is also possible to display such a combination of main text+sub text 1+sub text 2, for example a combination of three languages of Japanese, English, and Chinese, or a combination of more languages.

### Embodiment 2

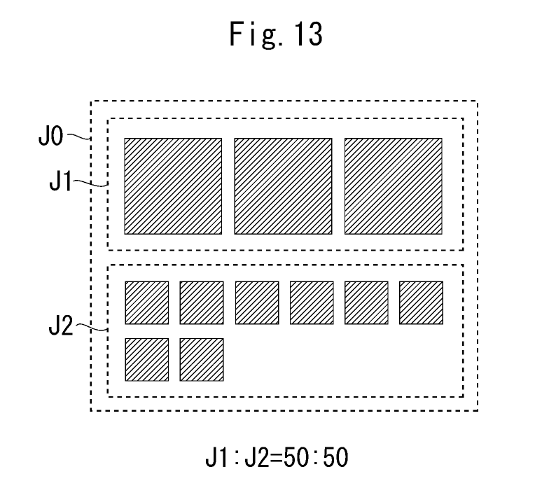

In Embodiment 1, the user operates the display-area-size-ratio input unit 12 to change a display area size ratio between main and sub text display areas; however, instead of the display-area-size-ratio input unit, a character-size-ratio input unit to change a display character size ratio between main and sub texts may be provided. For example, in a case where the main text is first language and the sub text is second language, although the same contents are expressed, the lengths of strings are sometimes different between the respective languages. If the display area size ratio is 50:50 in this case, strings having different lengths are fitted to the same size areas, causing a difference in character sizes used for the main and sub texts (FIG. 13). Even though area sizes of display areas are equal, character sizes different therebetween make a difference in visibility, which does not mean that “50:50=equal visibility”.

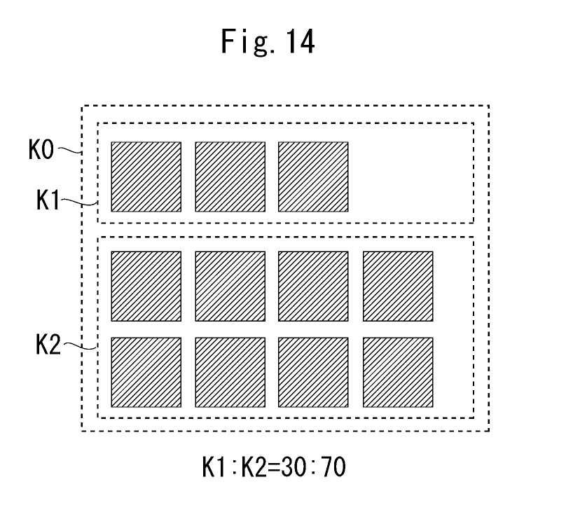

Then, the display-area-size-ratio input unit 12 (FIG. 2) is replaced with the character-size-ratio input unit to convert a ratio specified by the character-size-ratio input unit into a character size, whereby the specified ratio can be made closer to the visibility ratio between the main and sub texts. FIG. 14 shows a state in which the character size ratio between the first and second languages whose description lengths are different is specified at 50:50. In this figure, the display area size ratios between the main and sub texts are 30:70, but those character sizes are equal; therefore, no remarkable difference is produced in visibility.

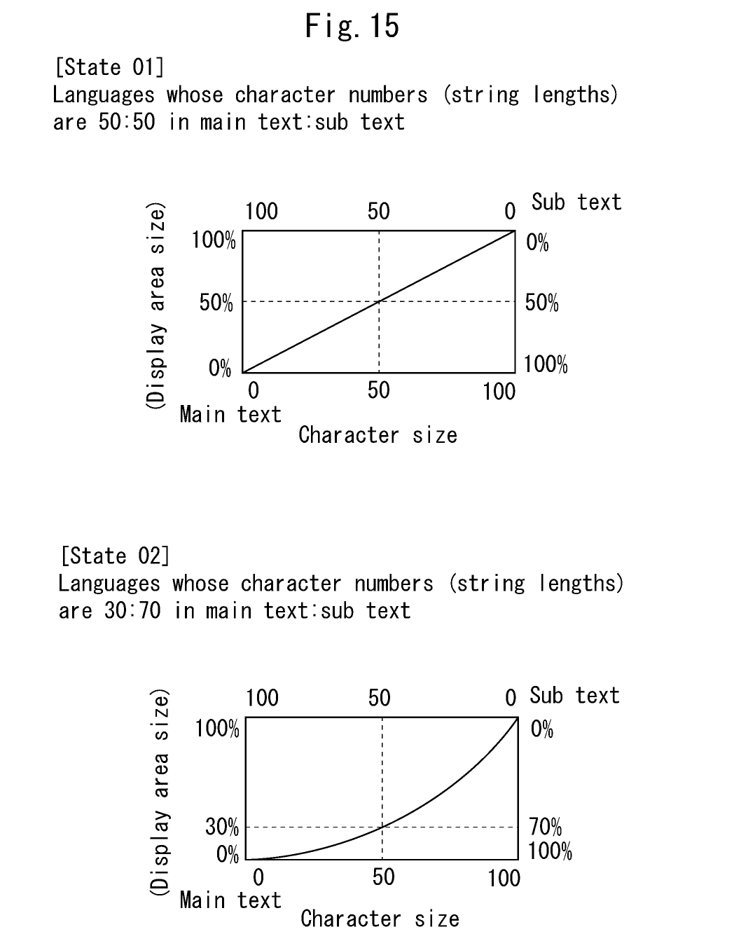

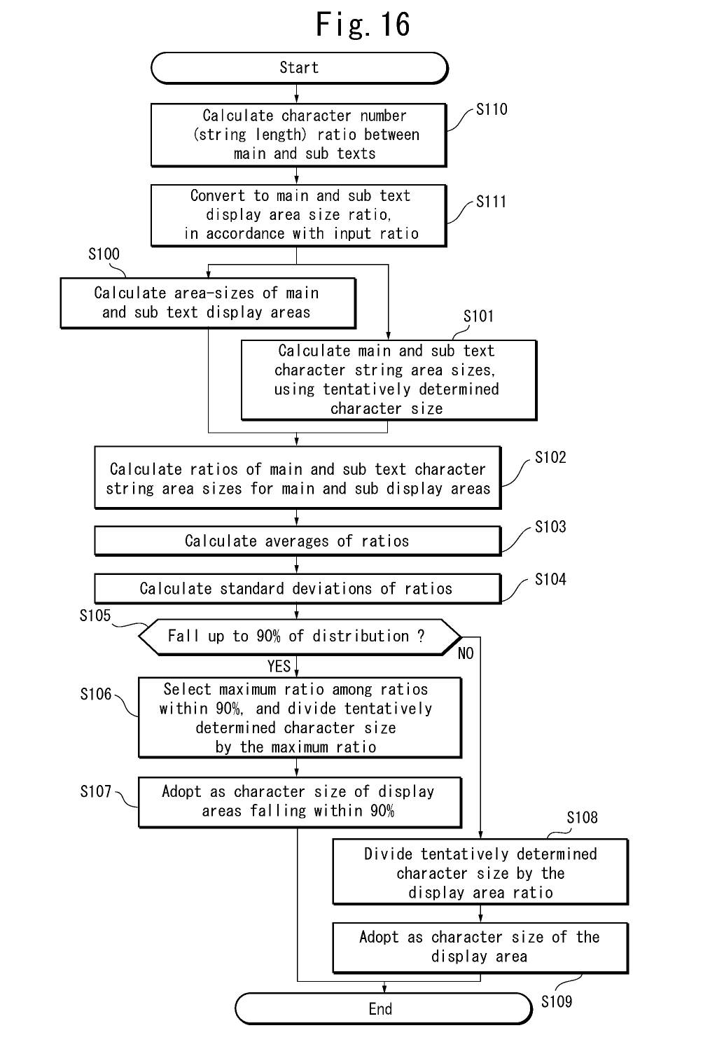

In order to convert a display area ratio specified by the user through an operation of the character-size-ratio input unit 12, to a character size ratio, a conversion proportion may be stipulated using graphs such as FIG. 15. FIG. 16 is a flow chart showing a process in Embodiment 2 of the present invention to uniformalize character sizes, and explaining about a process (S5) of the character size control unit 6 in FIG. 1. Firstly, the number of characters in a main text string and the number of characters in a sub text string are calculated. From the calculated results, a length ratio between the main text and sub texts is calculated (S110). Next, a graph as shown in FIG. 15 is drawn (S111) in which the horizontal axis indicates display character sizes and the vertical axis indicates the display area size of the main text or the sub text. For example, when the lengths of the main text string and the sub text string that have a same character size are almost the same, the relation between character size and display area size in the main text and the sub text is expressed as a linear graph shown in state 01 of FIG. 15. When the string lengths of the main text and the sub text are 30:70, the relation between character size and display area size in the main text or the sub text is similarly expressed as a curved line graph shown in state 02 of FIG. 15. A ratio of 50:50 sensed as an appearance visibility ratio between main and sub texts possibly depends on users; therefore, an interface may be adopted by which a user can arbitrarily set a curved graph according to situations. By utilizing the graph, a display character size ratio inputted from the display-character-size input unit 12 can be converted to a display area size ratio. On the basis of the obtained display area size ratio, S100, S101 and processes after those will be performed. The flow of S100, S101 and processes after those are equivalent to those described in FIG. 5.

### Embodiment 3

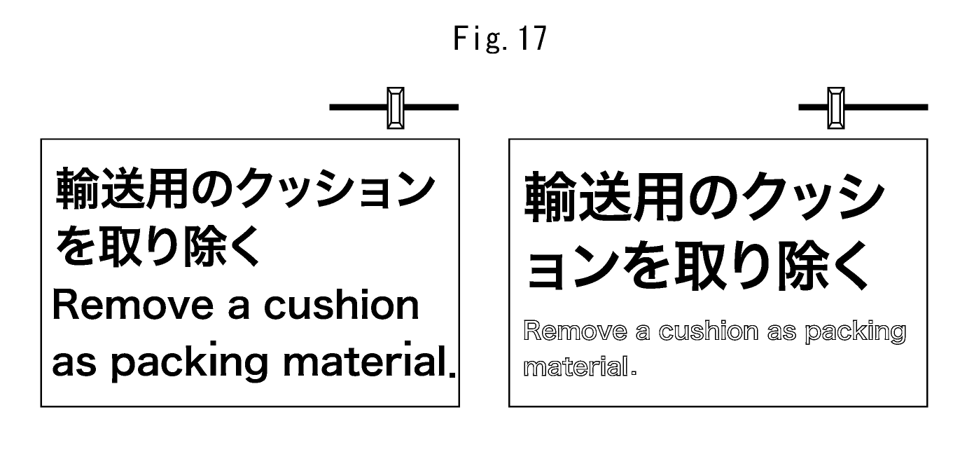

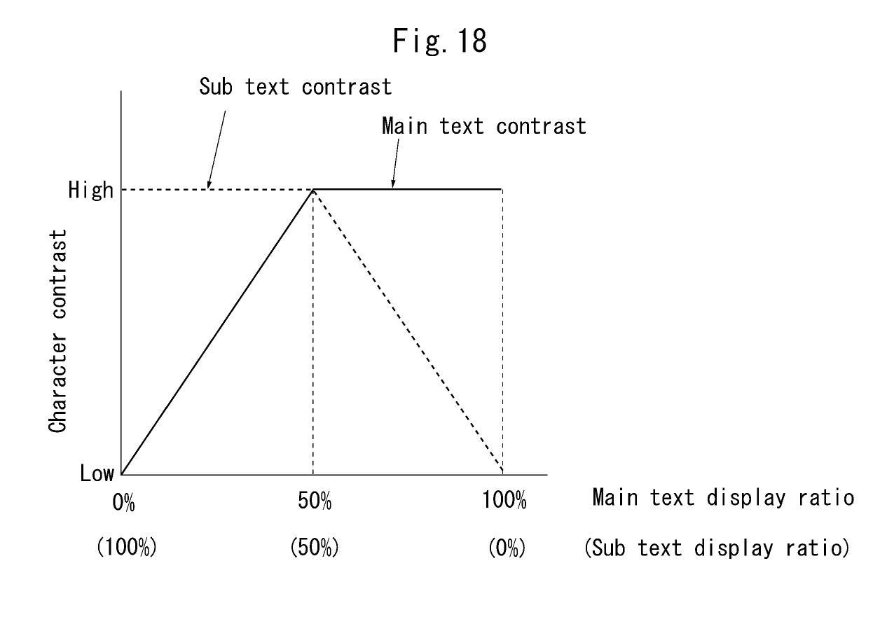

Furthermore, string visibility may be adjusted by using not only ratios of display areas or character sizes, but also variation in character color. In FIG. 17, ratios of display areas or character sizes are related to character visibility, to show a state in which when display areas and character sizes of main text and sub text are equal, the texts are displayed in equal visibility (equally deep in character darkness), and show a state in which when the display area or character size in either main text or sub text becomes smaller, the smaller one is displayed in low visibility (faint in character darkness). Here, the character visibility refers to contrast between character color and base color (ground color) of the display area; the higher the contrast, the more clearly the characters can be noticed; and the lower the contrast, the lower the character visibility becomes. FIG. 18 shows a relation between display area or character size and character visibility, in which a boundary ratio of 50:50 is set, so that when the ratio of either main text or sub text becomes smaller than the boundary ratio, the visibility becomes lower according to ratio.

### Embodiment 4

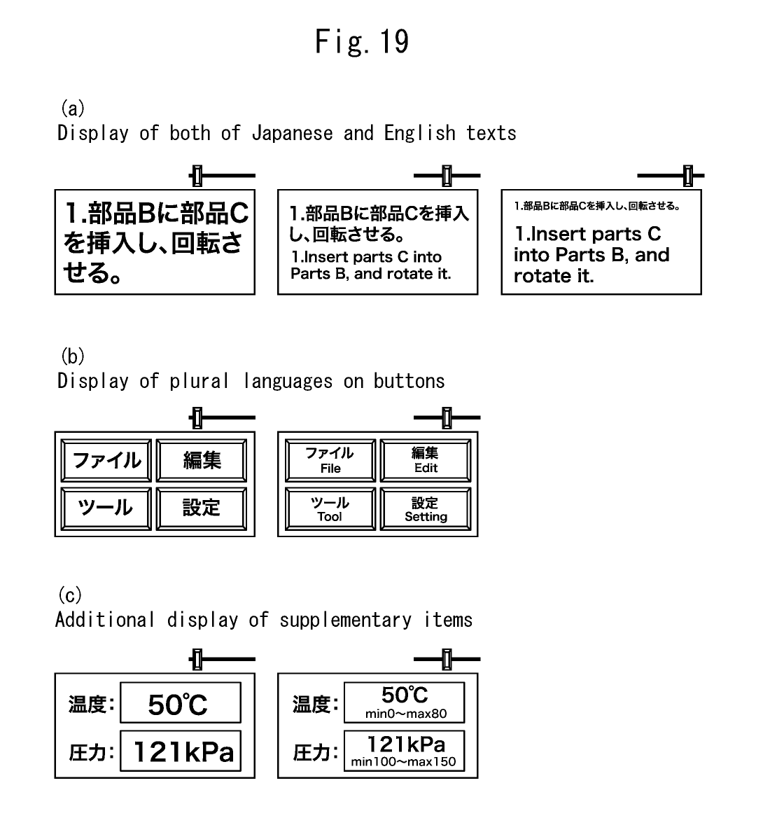

FIG. 19 are specific examples of Embodiment 4. In (a), examples are shown in which Japanese texts are the main texts, English texts translated therefrom are the sub texts, and they are displayed in main and sub text display areas at arbitrary ratios. In (b), examples are shown in which, in order that users whose native languages are different can operate a single device at the same time, Japanese function names and English function names are displayed as main texts and sub texts, respectively while the display area size ratios between the main and sub texts and the display character size ratios therebetween are adjusted. In (c), examples are shown in which measurements of temperature and pressure are main texts, and minimum and maximum values thereof are sub texts to be displayed together as supplementary items.

### NUMERAL EXPLANATION

1 input unit
2 input control unit
3 process-dependent determination unit
4 process-dependent definition file
5 display area control unit
6 string format control unit
7 string format determination unit
8 display-content recording unit
9 output control unit
10 display unit
11 display-content storage file
12 display-area-size-ratio input unit and display character-size-ratio input unit
13 back-and-forth page-turning input unit
14 image expansion-and-reduction input unit
A0 composite display area A
A1 main text display area A
A2 sub text display area A
B0 composite display area B
B1 main text display area B
B2 sub text display area B
C0 composite display area C
C1 main text display area C
C2 sub text display area C

1. A character string display device comprising:
a display on which plural composite display areas are arranged each of which has a fixed area and includes a main text display area and a sub text display area whose display areas are mutually variable;
a display-content recorder to record display data including the main and sub text display areas to be displayed in the composite display areas and main and sub text strings formatted to be displayed in the main and sub text display areas, respectively;
a display-area-ratio input device with which a display area ratio between the main and sub text display areas is inputted; and
a character size controller
to calculate the main and sub text display areas in accordance with the display area ratio,
calculate, using string lengths of main texts and string lengths of sub texts, a common character size for the strings of main texts and a common character size for the strings of sub texts so that the strings of the main and sub texts recorded in the display-content recorder can be arranged in the calculated main and sub text display areas, respectively, and
change the display data including the main and sub text display areas recorded in the display-content recorder and the main and sub text strings recorded therein, into display data including the calculated main and sub text display areas and the main and sub text strings with their character sizes set at the respective common character sizes.

2. The character string display device according to claim 1, wherein the character size controller calculates individual string areas of the main and sub texts under a condition that plural main and sub text strings recorded in the display-content recorder are displayed with respective common character sizes determined tentatively; from the string areas of the main and sub texts and the display areas of the main and sub texts calculated in accordance with the display area ratio, the character size controller obtains individual ratios between main text string areas and main text display areas and individual ratios between sub text string areas and sub text display areas; and on the basis of the ratios individually obtained, the character size controller calculates a common character size for the main text strings and a common character size for the sub text strings so that the strings of the plural main texts and sub texts can be arranged within the calculated main text display areas and the calculated sub text display areas.

3. The character string display device according to claim 2, wherein the character size controller selects a maximum value among the ratios between the plural main text string areas and main text display areas, and selects a maximum value among the ratios between the plural sub text string areas and sub text display areas; the character size controller divides the common character sizes tentatively determined for the main text strings and the sub text strings by the respective maximum values, to calculate, using the division results, a common character size for the main text strings and a common character size for the sub text strings.

4. The character string display device according to claim 3, wherein the character size controller obtains a standard deviation of the ratios between the plural main text string areas and main text display areas, and a standard deviation of the ratios between the plural sub text string areas and sub text display areas; and the character size controller selects respective maximum values below respective upper limit values predetermined on the basis of the respective standard deviations, among the ratios between the plural main text string areas and main text display areas, and among the ratios between the plural sub text string areas and sub text display areas, to divide the respective common character sizes tentatively determined for the main and sub texts by the respective maximum values.

5. The character string display device according to claim 4,
wherein with respect to a main text display area in which the ratio between the plural main text string areas and main text display areas is the predetermined upper limit value or larger, the character size controller divides the common character size predetermined for the main text by the ratio between the main text string areas and main text display area, and
wherein with respect to a sub text display area in which the ratio between the plural sub text string areas and sub text display areas is the predetermined upper limit value or larger, the character size controller divides the common character size predetermined for the sub text by the ratio between the sub text string area and sub text display area.

6. The character string display device according to any one of claims 1 to 5, further comprising:
a main text display color controller to set to the main text string, in a case where the main text display area is smaller than the sub text display area on the basis of a display area ratio inputted through the display-area-ratio input device, a character color less visible than that set to the sub text string;
a sub text display color controller to set to the sub text string, in a case where the sub text display area is smaller than the main text display area on the basis of the display area ratio, a character color less visible than that set to the main text string; and
an output controller to assign colors to the strings in the plural composite display areas on the basis of the character colors set by the main text display color controller and the sub text display color controller.

7. A character string display device comprising:
a display on which plural composite display areas are arranged each of which has a fixed area and includes a main text display area and a sub text display area whose display areas are mutually variable;
a display-content recorder to record display data including the main and sub text display areas to be displayed in the composite display areas and main and sub text strings formatted to be displayed in the main and sub text display areas, respectively;
a display-character-size-ratio input device including
an input value converter to convert, on the basis of each of area ratios between main text strings and sub text strings when displayed at a common character size, a display character size ratio between strings of a main text and a sub text to a display area ratio between display areas for the main text and the sub text; and
a character size controller
to calculate areas of the main and sub text display areas in accordance with the display area ratio,
calculate, using string lengths of main texts and string lengths of sub texts, a common character size for the strings of main texts and a common character size for the strings of sub texts so that the strings of the main and sub texts recorded in the display-content recorder can be arranged in the calculated main and sub text display areas, respectively, and
change the display data including the main and sub text display areas recorded in the display-content recorder and the main and sub text strings recorded therein, into display data including the calculated main and sub text display areas and the main and sub text strings with their character sizes set at the respective common character sizes.

8. The character string display device according to claim 7, further comprising:
a main text display color controller to set to the main text string, in a case where a main text display character size is smaller than a sub text display character size on the basis of the display character size ratio inputted from the display-character-size-ratio input device, a character color less visible than that set to the sub text string;
a sub text display color controller to set to the sub text string, in a case where the sub text display character size is smaller than the main text display character size on the basis of the display character size ratio, a character color less visible than that set to the main text string; and
an output controller to assign colors to the strings in the plural composite display areas on the basis of the character colors set by the main text display color controller and the sub text display color controller.
